(19) United States
(12) Patent Application Publication
(10) Pub. No.: US 2001/0033296 A1
(43) Pub. Date: Oct. 25, 2001

(54) Method and apparatus for delivery and presentation of data

(76) Inventors: Nathan W. Fullerton, Pittsburgh, PA (US); Michael L. Yacht, Pittsburgh, PA (US)

Correspondence Address: KUDIRKA & JOBSE, LLP, ONE STATE STREET, SUITE 1510, BOSTON, MA, 02109, US

(21) Appl. No.: 09/764,633

(22) Filed: Jan. 18, 2001

Related U.S. Application Data
(60) Provisional application No. 60/177,493, filed on Jan. 21, 2000.

(51) Int. Cl. G06F 3/14

(52) U.S. Cl. 345/730; 345/853

(57) ABSTRACT

A system including a player application and single data file allows for different data types or media, imbedded in a single data stream, to be presented in a format which includes windows for simultaneous display of a presentation, an abstract outline of the presentation and linking data to other relevant resources. The presentation content, outline and linking data are linked to allow for more efficient navigation and interaction with the presentation. User-selectable commands and/or navigation controls may be presented in predefined regions, e.g. hot buttons, of the presentation window to allow for greater interactivity beyond mere playback of the streamed presentation data.

### RELATED APPLICATIONS

This application claims priority to U.S. Provisional Patent Applications Ser. No. 60/177,493, Attorney Docket No. 10040/7000V1, by Nathan Fullerton and Michael Yacht, entitled “Method And Apparatus For Delivery and Presentation of Multimedia Data” filed on Jan. 21, 2000 and commonly assigned.

### FIELD OF THE INVENTION

This invention relates generally to improvements in computer systems and, more particularly, to a player application which allows for playback and presentation of multiple data types media from a single file.

### BACKGROUND OF THE INVENTION

Multimedia presentations have be used for educational and training purposes in academia, industry, government and business for decades. The computer revolution and other technological advancement have been used to improve the quality of such presentations. Most recently, the advent of the Internet and page based interactive presentations has enabled a whole new field of multimedia presentations. One of the most significant stumbling blocks to planning and developing effective interactive media is “thinking interactively.” Experienced trainers are used to linear progressions of information, i.e., one concept to the next. To create effective page-based interactive media, trainers need to break out of this linear mindset and think non-linearly. To compound this problem even experienced interactive designers know that to be pedagogically correct, user's actions need to be limited and monitored to assure that information is being properly assimilated by the users. In a totally non-linear page-based setting, where information flow follows many paths and has many links back and forth, many design complications arise, as shown by the conceptual illustration of FIG. 1. Design, tracking, and verification of such a presentation causes not only significant authoring and programming tasks, but significant planning tasks.

By contrast, video is a widely understood medium. It follows a linear progression that closely matches the way trainers have been thinking and presenting for years. But since digital video inherits many of the advantages of other computer-based media annotations, links, tracking, random-access, searching, etc.—it also inherits the effectiveness of traditional page-based multimedia approaches. Using video, training planners can avoid many of the potential problems encountered when moving to interactive multimedia.

Accordingly, it would be desirable to have an interactive multimedia presentation which is formatted as a video presentation but which utilizes all the advantages of computer based media.

Another obstacle to creating and presenting meaningful presentations is that most interactive multimedia options use the application model, in which each piece of presentation content is compiled into its own executable. This model requires installation of a new application for each piece of content.

In contrast, in the player and data delivery model, a single player application is installed on a user's local hard disk. Using this player application the user can access any compatible data file. That file can be accessed locally or from removable media or over a network.

Accordingly, it would be further desirable to construct a player using the player and data model which is capable of playing a compatible data file which includes different data types and formats to facilitate effective presentations.

### SUMMARY OF THE INVENTION

A system including a player application and single data file allows for different data or media types, imbedded in a single data stream, to be presented in a format which includes windows for simultaneous display of a presentation, an abstract outline of the presentation and linking data to other relevant resources. The presentation content, outline and linking data are linked to allow for more efficient navigation and interaction with the presentation. User-selectable commands and/or navigation controls may be presented in predefined regions, e.g. hot buttons, of the presentation window to allow for greater interactivity beyond mere playback of streamed data.

The inventive system, referred to hereafter as the Discourse system 200 uses a single data file 205 to hold all the media for the main linear content stream of Discourse file. This single data file 205 contains the sound, video, still graphics, transcript, annotations, and other media or data types that can be included in a Discourse presentation. Discourse system 200 has the ability to read indexed streamed data and embedded commands. In addition, as explained hereafter, the user interface 230 presents close captioning and selectable hot buttons (regions), as well as relevant links and searching capabilities, through which a viewer can interact with the presentation. Discourse system comprises a Discourse player, media engine, user interface and Discourse data file. The Discourse player 225 uses a media engine for the file input/output and for the actual display of video and audio information to the user interface, in conjunction with the operating system.

The Discourse system is a combination of a multimedia data file format, a player and application. Optional authoring tools and various administrative utilities help manage large numbers of data files. The Discourse Player is a digital video-based system designed to facilitate rapid production and dissemination of information in an effective interactive format.

According to a first aspect of the present invention, an apparatus for displaying content from a data file comprises: a media engine for presenting content data from the data file; program logic for streaming content data from the data file and for coordinating a presentation of the content data by the media engine, the presentation having a plurality of data segments; program logic for displaying an outline of the presentation during display of the presentation; and program logic for accessing one of the plurality of data segments within the presentation upon selection of a corresponding portion of the outline of the presentation.

According to a second aspect of the present invention, in a computer system having a display and capable of generating a presentation from a stream of data, a method comprising: (a) accessing the stream of data; (b) extracting content data from the stream of data; (c) presenting the content data on the display; (d) extracting outline data representing a plurality of data segments within the presentation, the data segments linked to respective segments of the presentation; and (e) presenting the outline data on the display simultaneously with the presentation of the content data.

According to a third aspect of the present invention, a computer program product for use with a computer system having a display and capable of generating a presentation from a stream of data, the computer program product comprising a computer useable medium having program code embodied therein comprising: (a) program code for accessing the stream of data; (b) program code for extracting content data from the stream of data; (c) program code for presenting the content data on the display; (d) program code for extracting outline data representing a plurality of data segments within the presentation, the data segments linked to respective segments of the presentation; and (e) program code for presenting the outline data on the display simultaneously with the presentation of the content data.

According to a fourth aspect of the present invention, In a computer system having a display and capable of generating a presentation from a stream of data, a method comprising: (a) accessing the stream of data; (b) extracting content data from the stream of data; (c) presenting the content data on the display; (d) extracting linking data representing at least one link to data other than the presentation data associated therewith, the linking data linked to other data sources; and (e) presenting the linking data on the display simultaneously with the presentation of the content data.

According to a fifth aspect of the present invention, a computer program product for use with a computer system having a display and capable of generating a presentation from a stream of data, the computer program product comprising a computer useable medium having program code embodied therein comprising: (a) program code for accessing the stream of data; (b) program code for extracting content data from the stream of data; (c) program code for presenting the content data on the display; (d) program code for extracting linking data representing at least one link to data other than the presentation data associated therewith, the linking data linked to other data sources; and (e) program code for presenting the linking data on the display simultaneously with the presentation of the content data.

According to a sixth aspect of the present invention, in a computer system having a display and capable of generating a presentation from a stream of data, a method comprising: (a) accessing the stream of data; (b) extracting content data from the stream of data; (c) presenting the content data on the display; (d) extracting selection data representing at least one user-selectable region within the presentation of the content data, the user-selectable region associated with a command; and (e) modifying the presentation of the content data upon selection of the user-selectable region associated with a selectable command.

According to seventh aspect of the present invention, in a computer system having a display and capable of generating a presentation from a stream of data, a method comprising: (a) providing a data file containing a stream of data having internal commands and user selectable options interleaved in the stream with presentation data; (b) extracting the presentation data from the data file and generating a presentation thereof; (c) extracting the internal commands from the data stream and interpreting the internal commands; (d) extracting the user selectable options from the data stream and presenting the user selectable options superimposed over the presentation; and (e) manipulating the presentation in response to selection of one of the user selectable options.

According to an eight aspect of the present invention, an apparatus for displaying content from a data file comprises: a media engine for presenting content data from the data file; program logic for streaming content data from the data file and for coordinating a presentation of the content data by the media engine, the presentation having a plurality of data segments and relevant links from the data stream to other data; and program logic for displaying an outline of the presentation and relevant links from the data stream to other data during display of the presentation.

### BRIEF DESCRIPTION OF THE DRAWINGS

The above and other features, objects and advantages of the invention will be better understood by referring to the following detailed description in conjunction with the accompanying drawing in which:

FIG. 1 is a conceptual diagram of a typical linking arrangement among a plurality of pages in a multimedia presentation;

FIG. 2 is a conceptual block diagram of a computer system suitable for use with the present invention;

FIG. 3 is a conceptual block diagram of the Discourse player and data file of the present invention;

FIG. 4 is a conceptual diagram of the objects utilized to implement the Discourse player of the present invention and the control flow between the objects;

FIGS. 5A-D form a flowchart of the process steps performed by the Discourse system to set up and play a Discourse data file of the present invention;

FIG. 6 is a screen display of the user interface of the Discourse player of the present invention showing multiple windows; and

FIG. 7 is a conceptual diagram of a the data stream presentation as generated by the present invention and the possible linking arrangements to other data.

### DETAILED DESCRIPTION OF THE PREFERRED EMBODIMENT

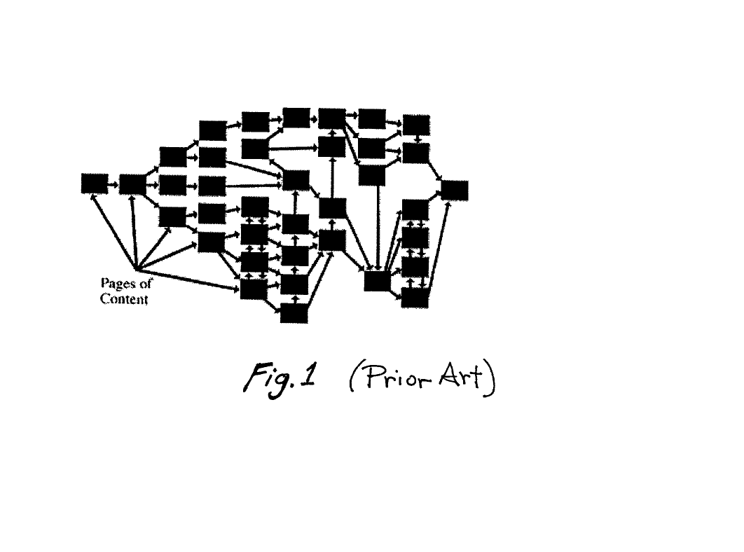

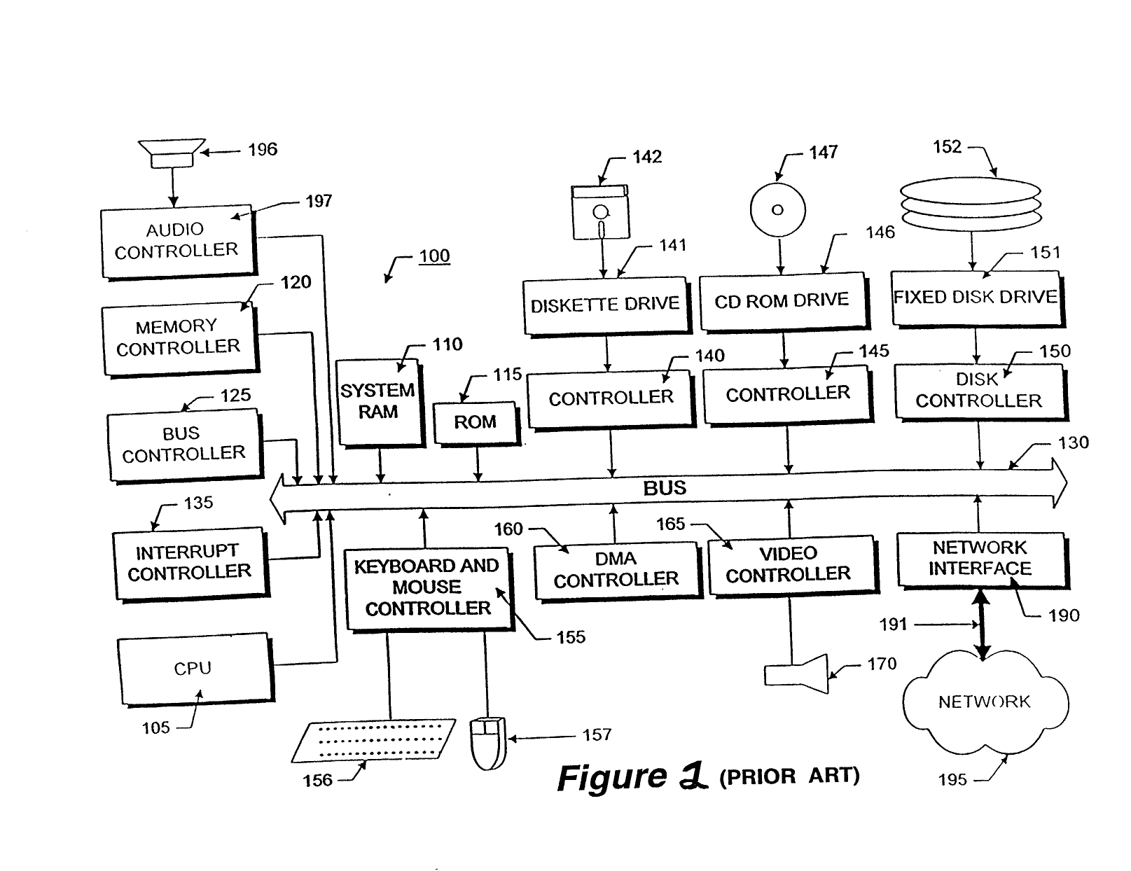

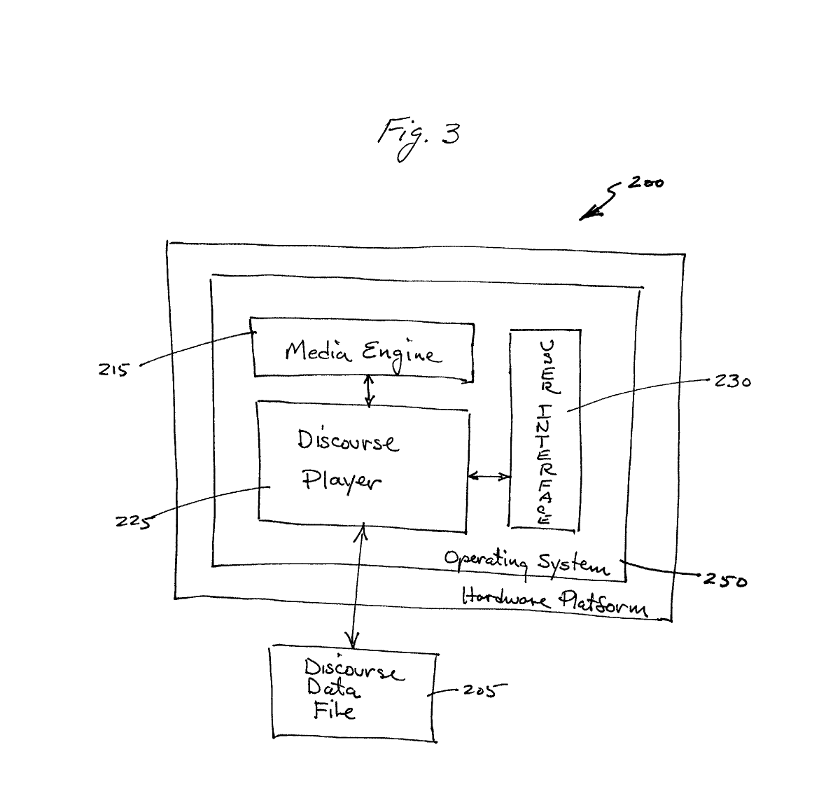

FIG. 2 illustrates the system architecture for a computer system 100 such as an IBM PS/2®, on which the invention may be implemented. The exemplary computer system of FIG. 1 is for descriptive purposes only. Although the description may refer to terms commonly used in describing particular computer systems, such as in IBM PS/2 computer, the description and concepts equally apply to other systems, including systems having architectures dissimilar to FIG. 2.

Computer system 100 includes a central processing unit (CPU) 105, which may be implemented with a conventional microprocessor, a random access memory (RAM) 110 for temporary storage of information, and a read only memory (ROM) 115 for permanent storage of information. A memory controller 120 is provided for controlling RMA 110.

A bus 130 interconnects the components of computer system 100. A bus controller 125 is provided for controlling bus 130. An interrupt controller 135 is used for receiving and processing various interrupt signals from the system components.

Mass storage may be provided by diskette 142, CD ROM 147, or hard drive 152. Data and software may be exchanged with computer system 100 via removable media such as diskette 142 and CD ROM 147. Diskette 142 is insertable into diskette drive 141 which is, in turn, connected to bus 30 by a controller 140. Similarly, CD ROM 147 is insertable into CD ROM drive 146 which is, in turn, connected to bus 130 by controller 145. Hard disk 152 is part of a fixed disk drive 151 which is connected to bus 130 by controller 150.

User input to computer system 100 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices, such as a pen and/or tabloid may be connected to bus 130 and an appropriate controller and software, as required. DMA controller 160 is provided for performing direct memory access to RAM 110. A visual display is generated by video controller 165 which controls video display 170. Computer system 100 also includes a communications adaptor 190 which allows the system to be interconnected to a local area network (LAN) or a wide area network (WAN), schematically illustrated by bus 191 and network 195.

Operation of computer system 100 is generally controlled and coordinated by operating system software, such as the Windows 98 or Windows NT operating system, available from Microsoft Corp. Redmond, WA. The operating system controls allocation of system resources and performs tasks such as processing scheduling, memory management, networking, and I/O services, among things. In particular, an operating system 205 resident in system memory and running on CPU 105 coordinates the operation of the other elements of computer system 100. The present invention may be implemented with any number of other commercially available operating systems including OS/2, UNIX, Linux and Solaris, etc. If operating system 250 is a true multitasking operating system, multiple applications may execute simultaneously.

In a preferred embodiment, various elements of Discourse system 200 are implemented in the C++ programming language using object-oriented programming techniques. C++ is a compiled language, that is, programs are written in a human-readable script and this script is then provided to another program called a compiler which generates a machine-readable numeric code that can be loaded into, and directly executed by, a computer. As described below, the C++ language has certain characteristics which allow a software developer to easily use programs written by others while still providing a great deal of control over the reuse of programs to prevent their destruction or improper use. The C++ language is well-known and many articles and texts are available which describe the language in detail. In addition, C++ compilers are commercially available from several vendors including Borland International, Inc. and Microsoft Corporation. Accordingly, for reasons of clarity, the details of the C++ language and the operation of the C++ compiler will not be discussed further in detail herein.

As will be understood by those skilled in the art, Object-Oriented Programming (OOP) techniques involve the definition, creation, use and destruction of “objects”. These objects are software entities comprising data elements, or attributes, and methods, or functions, which manipulate the data elements. The attributes and related methods are treated by the software as an entity and can be created, used and deleted as if they were a single item. Together, the attributes and methods enable objects to model virtually any real-world entity in terms of its characteristics, which can be represented by the data elements, and its behavior, which can be represented by its data manipulation functions. In this way, objects can model concrete things like people and computers, and they can also model abstract concepts like numbers or geometrical designs.

Objects are defined by creating “classes” which are not objects themselves, but which act as templates that instruct the compiler how to construct the actual object. A class may, for example, specify the number and type of data variables and the steps involved in the methods which manipulate the data. When an object-oriented program is compiled, the class code is compiled into the program, but no objects exist. Therefore, none of the variables or data structures in the compiled program exist or have any memory allotted to them. An object is actually created by the program at runtime by means of a special function called a constructor which uses the corresponding class definition and additional information, such as arguments provided during object creation, to construct the object. Likewise objects are destroyed by a special function called a destructor. Objects may be used by using their data and invoking their functions. When an object is created at runtime memory is allotted and data structures are created.

The principle benefits of object-oriented programming techniques arise out of three basic principles; encapsulation, polymorphism and inheritance. More specifically, objects can be designed to hide, or encapsulate, all, or a portion of, the internal data structure and the internal functions. More particularly, during program design, a program developer can define objects in which all or some of the attributes and all or some of the related functions are considered “private” or for use only by the object itself. Other data or functions can be declared “public” or available for use by other programs. Access to the private variables by other programs can be controlled by defining public functions for an object which access the object's private data. The public functions form a controlled and consistent interface between the private data and the “outside” world. Any attempt to write program code which directly accesses the private variables causes the compiler to generate an error during program compilation which error stops the compilation process and prevents the program from being run.

Polymorphism is a concept which allows objects and functions which have the same overall format, but which work with different data, to function differently in order to produce consistent results. For example, an addition function may be defined as variable A plus variable B (A+B) and this same format can be used whether the A and B are numbers, characters or dollars and cents. However, the actual program code which performs the addition may differ widely depending on the type of variables that comprise A and B. Polymorphism allows three separate function definitions to be written, one for each type of variable (numbers, characters and dollars). After the functions have been defined, a program can later refer to the addition function by its common format (A+B) and, at runtime, the program will determine which of the three functions is actually called by examining the variable types. Polymorphism allows similar functions which produce analogous results to be “grouped” in the program source code to produce a more logical and clear program flow.

The third principle which underlies object-oriented programming is inheritance, which allows program developers to easily reuse pre-existing programs and to avoid creating software from scratch. The principle of inheritance allows a software developer to declare classes (and the objects which are later created from them) as related. Specifically, classes may be designated as subclasses of other base classes. A subclass “inherits” and has access to all of the public functions of its base classes just as if these function appeared in the subclass. Alternatively, a subclass can override some or all of its inherited functions or may modify some or all of its inherited functions merely by defining a new function with the same form (overriding or modification does not alter the function in the base class, but merely modifies the use of the function in the subclass). The creation of a new subclass which has some of the functionality (with selective modification) of another class allows software developers to easily customize existing code to meet their particular needs.

Discourse Player System

The Discourse system 200 uses the player/data file model similar to many other multimedia programs available, however, Discourse system 200 uses a single file distribution. The player and data model greatly reduces the amount of support required for training and materials. Since only one application is installed, users' systems aren't compromised by repeated modifications to critical system files. Additionally, the player and data model improves compatibility, since there's no risk of a new piece of content overwriting files needed by older ones. The player and data model also greatly enhances portability and reusability. Because the data and executable code are kept strictly separate, the same data files can be used on multiple platforms. This feature also protects creators' investments in media. Since the data is so portable, a radical shift in the landscape of the computer industry will not make Discourse materials obsolete.

By separating the data from the player, Discourse system 200 is able to deliver a standard user interface regardless of the content. Accordingly, users will experience the same easy-to-use interface no matter the content. This standardization decreases the learning curve of each subsequent Discourse data file 205 viewed.

Discourse player 225 utilizes the QuickTime 4.0 media engine, commercially-available from Apple Computer, Cupertino, Calif., as its media player 215, to present the audio and video data using standard functionality which is already fully documented in the Quicktime API documentation. The data file 205, accordingly, may have a format similar to a Quicktime data file format. It will be obvious to those skilled in the relevant arts that other media engines may be used in place of the Quicktime media engine. For example, the Microsoft Media Player engine, commercially available from Microsoft Corp, Redmond Wash. Alternatively, any media engine that complies with the MPEG 4.0 standard or subsequent revisions may also be used a media engine 215.

The Discourse system 200 uses a single data file 205 to hold all the media for the main linear content stream of Discourse file. This single data file 205 contains the sound, video, still graphics, transcript, annotations, and other media or data types that can be included in a Discourse project. Discourse system 200 has the ability to read indexed streamed data and embedded commands. In addition, as explained hereafter, the user interface 230 presents close captioning and selectable hot buttons (regions), as well as relevant links and searching capabilities, through which a viewer can interact with the presentation.

In the illustrative embodiment, at least four specific tracks are available within a Discourse presentation, including: one or more movie tracks; one or more audio tracks; one or more transcript tracks and one or more data tracks. The transcript track may be used for closed captioning of the audio content of another track. The data track may contain the syntax for outlines, imbedded commands, hotspots e.g., selectable items within the media stream, and links within a given section of a movie. With such track configuration, a portion of a movie may be accessed and the related data then accessed from an accompanying track.

FIG. 3 illustrates a block diagram of Discourse system 200 of the present invention. Discourse system 200 comprises a Discourse player 225, media engine 215, user interface 230 and Discourse data file 205, as illustrated. Discourse player 225 may use any number of commercially available media engines for the file input/output and for the actual display of video and audio information to the user interface, in conjunction with operating system 250. The coordination of all data and information is the responsibility of Discourse player 225. In the illustrative embodiment, Discourse player 225 is implemented as a software application using object oriented technology and is intended to execute in a multitasking, multi-threaded environment, such as that provided by Windows NT, Windows 98, Linux, MacOS, etc.

Discourse Player

Discourse player 225, may be implemented as an all software application executable an operating system 250. In the illustrative embodiment, Discourse Player may be implemented as a multi-threaded, object-oriented application. The use of multiple threads within the application enables multiple tasks within the application to change states simultaneously in response to various instream commands and user requests, as explained hereinafter. Discourse Player 225 utilizes a number of key objects to read data from Discourse data file 205, coordinate streaming and presentation of the data in conjunction with the media player, and to respond to search, navigation and linking commands from a user. This modular format allows for other objects to be easily added with complete backwards compatibility.

The objects used to implement Discourse player 225 include: CApp, CMovie, CMovieWnd, COutline, COutlineWnd, Clinks, ClinksWnd, CSearch, CSearchWnd and CCommand. The CApp object is the application controlling object for the operating system 250 and functions primarily to register and process threads. The CMovie object is the central controlling object, or engine, for the Discourse system 200. The CMovie object performs the coordination, control, input and output of data. The CMovieWnd is the interface (window/controls) for the movie itself. The CMovieWnd object functions as the central window. The COutline object is the ‘table of contents’ control for the movie. The COutlineWnd is the interface object for the outline. The CLinks object is the relevant links control for the movie. The CLinksWnd object is the interface object for the relevant links. The CSearch object is the search control for the movie. The CSearchWnd object is the interface for searching, generally will be a dialog box that pops up and disappears when done. The CCommand object is a the imbedded commands and selectable hotspots for the movie. The CCommand object is an interface less object. These objects can be organized into a Player 225 utilizes a number of different object group, including Movie number of different object group, including Move Objects, Outline Objects, Relevant Links Objects, Search Objects perform these activities. The key objects within theses groups as well as their functions and parameters are described in greater detail hereinafter.

Movie Objects

CMovie Object

The CMovie object is the primary object in the Discourse player 225 and is the primary object which interacts with media engine 215. In the illustrative embodiment, the Discourse player 225 may be implemented with a hub-and-spoke design in which the CMovie object is the central control for most functions performed by the Discourse player 225. This design is efficient since the Discourse system model enables all data and all actions to be linked to the central streaming data e.g., movie and/or audio. As used herein the term is not limited to video data but is intended to cover any content data which may be presented including audio, video, text, other data types or any combination thereof.

The CMovie object utilizes the following variables: OutlineObj; LinksObjl; SearchObj and CommandObj. The OutlineObj variable identifies the COutline object. The LinksObj variable identifies the CLinks object. The SearchObj variable identifies the CSearch object. The CommandObj variable identifies the CCommand object. The CMovie Object implements the following functions: Constructor, InterfaceConstructor, ToggleCC, ToggleOutline, ToggleLinks, OpenMovie, ScrubCallback, EndMovieCallback, NextSegmentCallback, GoToTime, PlayMovie, and StopMovie. The Constructor function is utilized to initialize all data, call Interface Constructor to do necessary construction, and create the OutlineObj, LinksObj, SearchObj and CommandObj objects. The input and output variables for the Constructor function are nil. The InterfaceConstructor function creates the CMovieWnd object. The input and output variables for the InterfaceConstructor function are nil. The ToggleCC function activates/deactivates the transcript text track according to the value of the boolean variable received. The input and output variables for the ToggleCC function are nil.

The ToggleOutline function includes the following variables and performs the following functions:

ToggleOutline(IN, nil, OUT: nil)

If COutlineWnd is enabled and shown, hide it through OutlineObj::ToggleOutline(false)

If COutlineWnd is enabled and not-shown, show it through OutlineObj::ToggleOutline(true)

The ToggleLinks function includes the following variables and performs the following functions:

ToggleLinks(IN: nil, OUT: nil)

If CLinksWnd is enabled and shown, hide it through LinksObj::ToggleLinks(false)

If CLinksWnd is enabled and not-shown, show it through LinksObj::ToggleLinks(true)

The OpenMovie function includes the following variables and performs the following functions:

OpenMovie(IN: nil, OUT: bool)

Get the filename of the movie to open. Do some basic error checking to make sure that the movie passes some very basic requirements (At least 1 video track, 1 audio track and 2 text tracks). If error checking fails, exit and return FALSE.

Read the movie in through Quicktime. If this fails, exit and return FALSE.

Piece through the tracks, see if it is a multilingual movie. If so, then make a list of all the languages, prompt the user with which language they wish to watch. If not multi-lingual then use the base language of the movie.

Find the transcript track of the language being viewed.

Find the data track of the language being viewed.

Parse through the data track, extract out the outline segments, creating a large list. Pass that list to OutlineObj::AddOutline. If that returns false, exit and return FALSE.

Check to see if there are any imbedded commands at the start of the movie. If so, pass those (individually) to CommandObj::DoCommand.

Extract out the data for the start of the movie from the data track. Remove any outline and imbedded command portions. Pass that to LinksObj::ParseLinks.

Set up the scrub-callback in Quicktime for the movie, point it to ScrubCallback. [If the user jumps around in the movie]

Set up the end-of-movie callback in Quicktime, point it to EndMovieCallback. [When the movie ends]

Set up the next-segment callback in Quicktime, point it to NextSegmentCallback. [When the next outline segment is reached]

Call PlayMovie.

The GoToTime function includes the following variables and performs the following functions:

GoToTime(IN: TimeValue, OUT: nil)

Call StopMovie.

Go to TimeValue in the movie.

Call StartMovie.

The CMovie object includes the following additional functions: ScrubCallback, EndMovieCallback, NextSegmentCallback, PlayMovie(IN: nil, OUT: nil), StopMovie(IN: nil, OUT: nil)

CMovieWnd Object

The CMovieWnd object is responsible for presenting window 232 in which a presentation or movie is displayed and includes the functions such as: HotspotClicked, DoSearch, DoStop, DoPlay, DoNextSegment, DoPreviousSegment, ToggleOutline, ToggleLinks, and ToggleClosedCaptioning.

Toolbar 240 provides the main functionality for navigating through a presentation. The three leftmost buttons of toolbar 240 are Show/Hide buttons (outline, links and close captioning, respectively). The middle four buttons of toolbar 240 are all navigation buttons, including previous topic, pause, play, next topic. Alternatively, the pause and play buttons may be combined into a single button that just toggles the current play state. The last button of toolbar 240 is the Search button and calls up the searching dialog. The movie controller 237 above the toolbar may be the standard Quicktime movie controller.

The menubar 242 includes File, Edit Preferences and Help options.

Outline Objects

COutline Object

The COutline object generates the outline of the Discourse presentation and utilizes the following functions: Constructor, InterfaceConstructor, Destructor, InterfaceDestructor, AddOutline, ParseOutlineString, GotoOutlineSegment, GotoOutlineString, NextSegment, PreviousSegment, ToggleOutline, and EnableOutline. The Constructor function initializes all data and calls InterfaceConstructor to do necessary construction. The InterfaceConstructor function creates the COutlineWnd object. The Destructor function destroys all data to prevent data loss and calls InterfaceDestructor, if necessary. The InterfaceDestructor function deletes the windows and controls. For the above-described COutline functions, the input and output variables are nil.

The remainder of the functions within the COutline object have the parameters and perform the functions as set forth below:

AddOutline(IN: string, OUT: bool)

Call ParseOutlineString on the string.

Call COutlineWnd::DisplayTree to move the abstract data into the interface. Return True if successful, or False if failure

ParseOutlineString (IN: string, OUT: int)

Take in the string and parse it into the abstract tree.

Return the total number of outline segments parsed, or −1 for a failure.

GotoOutlineSegment(IN: *abstractTreeElement, OUT: nil)

Go to the appropriate portion of the tree, grab the time value, tell the CMovie::GoToTime to go to that time.

GotoOutlineString(IN: string, OUT: bool)

Search the outline for the string. When found, tell the CMovie::GoToTime to go to that time.

Return true if successful, false if failed to find the outline segment.

NextSegment(IN: nil, OUT: nil)

Go to the next outline segment if there is one.

PreviousSegment(IN: nil, OUT: nil)

Go to the previous outline segment if there is one.

ToggleOutline(IN: bool, OUT: nil)

If the incoming argument is true, show the COutlineWnd object.

If the incoming argument is false, hide the COutlineWnd object.

EnableOutline(IN: bool, OUT: nil)

If the incoming argument is true, enable the COutlineWnd object.

If the incoming argument is false, disable and hide the COutlineWnd object.

COutlineWnd Object

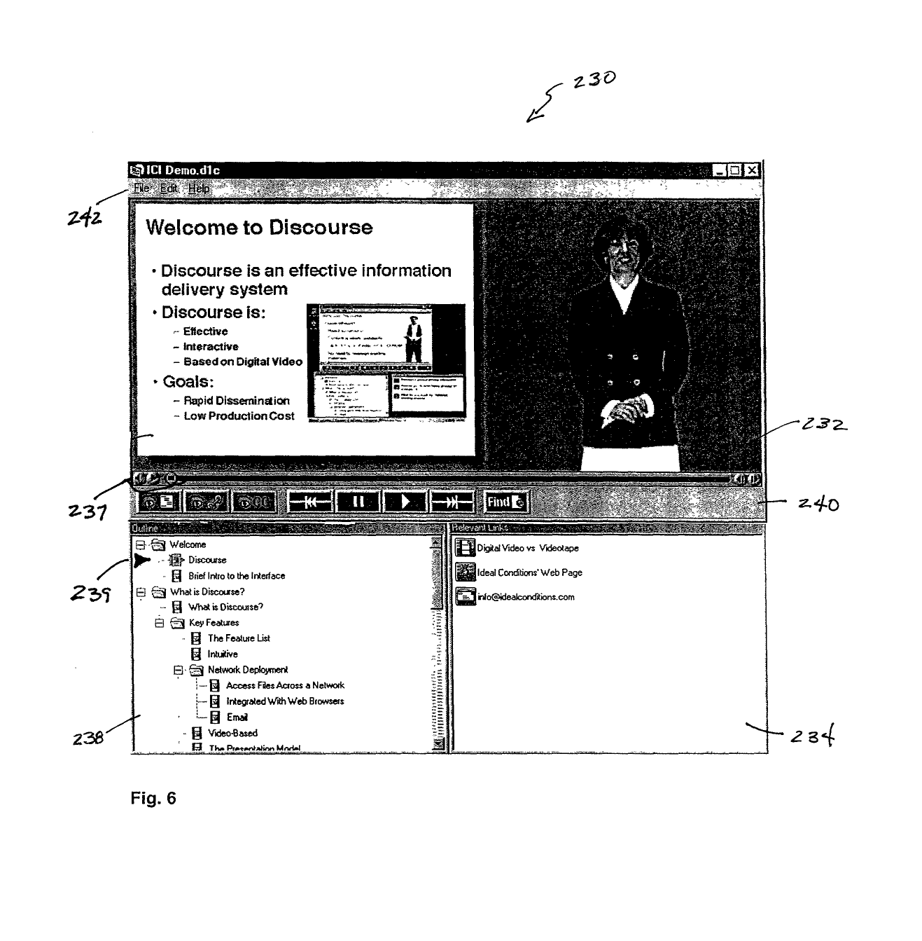

The COutlineWnd object displays the outline of the Discourse presentation, as illustrated in Windows 38 of FIG. 6. The primary function within this object is the Display Tree function which receives as an input variable an abstractTree and generates a boolean value output. The Display Tree function displays the received abstractTree within a window of the user interface 230 and returns a true value if successful, otherwise a false value.

Whenever a user selects a leaf of the Displayed Tree, the DisplayTree function determines the matching counterpart in the abstract Tree and calls the GotoOutlineSegment function of the COutline object and passes that element. Whenever a user selects a branch of the tree, the DisplayTree function accesses the immediate leaf of the branch and proceeds as if the leaf had been selected. In the illustrative embodiment, the branches/leaves of the Tree abstract may be expandable/collapsable.

A visible pointer 239, or other graphic element, indicates the current position of the movie on the abstract tree and moves as the presentation progresses. If the user slides the movie controller bar 237, and causes the pointer 239 to be removed from view, the pointer remains out of view until the Discourse Player 225 moves the pointer into view again. Double and single clicking the pointer may also be used to cause the pointer to disappear and reappear, respectively, on the display 238 in the same manner.

Relevant Links Objects

CLinks Object

The CLinks object is the relevant links control for the movie and has the functions and parameters as set forth below:

Constructor (IN: nil, OUT: nil)

Initialize all data

Must call InterfaceConstructor to do necessary construction

InterfaceConstructor(IN: nil, OUT: nil)

Create the COutlineWnd object.

Destructor (IN: nil, OUT: nil)

Destroy all data, to prevent data loss. This may not be necessary.

Call InterfaceDestructor. Again, may not be necessary.

InterfaceDestructor(IN: nil, OUT: nil)

Nuke all the windows and controls. Mostly unneeded in most IDEs

AddLinks(IN: String, OUT: bool)

Call CLinksWnd::ClearAllLinks to clear the interface.

Take the large string and pass it to ParseLinks. Store the int returned

Take the LinksList abstract and loop til the returned int from ParseLinks calling the CLinksWnd::AddLink function.

Return true if successful, return false if failed.

ParseLinks(IN: String, OUT: int)

Piece through the large string passed by CMovie and make the LinksList abstract object (literally a linked list of LinkElement abstracts).

DoLink(IN: int, OUT: bool)

The integer coming in is the ‘placement’ of the current link in the overall LinksList.

Parse the data stored in the corresponding Element and do the link.

If the link is an imbedded command, then pass that back to CMovie::DoCommand to parse.

ToggleLinks(IN: bool, OUT: nil)

If the incoming argument is true, show the CLinksWnd object.

If the incoming argument is false, hide the CLinksWnd object.

EnableLinks(IN: boot, OUT: nil)

If the incoming argument is true, enable the CLinksWnd object.

If the incoming argument is false, disable and hide the CLinksWnd object.

CLinksWnd Object

The CLinksWnd object is the interface object for the relevant links window 234 and has the functions and parameters as set forth below:

AddLink(IN: *LinkElement, OUT: bool)

Take the pointer to the LinkElement and figure out what type of link it is. Display it appropriately in the control.

Clear all the links. Pretty straight forward.

Within window 234 is a List Control. On the left hand side of the list an icon represents the type of link that is being displayed, e.g., a movie icon for a movie, a web-icon for an HTML page, etc. To the right of the icon is text describing the link. Selection of one of the icons by a user causes the link to be resolved to its resource.

Search Objects

CSearch Object

The CSearch object is the search control for the movie and is associated with the search button on toolbar 240. The CSearch object has the functions and parameters as set forth below:

Constructor (IN: nil, OUT: nil)

Initialize all data

Destructor (IN: nil, OUT: nil)

Destroy all data, to prevent data loss. This may not be necessary.

DoSearch(IN: nil, OUT: TimeValue)

Check to see if a search has been done before. If not: Then call PreloadSearchData.

Call DoSearchDialog

Get the results from DoSearchDialog, pass it back to CMovie as what time to skip to.

PreloadSearchData(IN: nil, OUT: int)

Do a loop that turns the transcript from CMovie into an abstract linked list.

Return the total number of transcript segments.

DoSearchDialog(IN: nil, OUT: TimeValue)

Call the CSearchWnd dialog modally.

When the dialog closes, it will return the time value of the clicked element or −1 for none. Pass that back.

CsearchWnd Object

The CSearchWnd object is the interface for searching within the presentation. The interface may be implemented with a dialog box that appears and disappears when done, depending on how the operating system 250 renders dialog boxes. The interface exits on a double click within the selection (The TimeValue of that segment), or when the user selectscancel (−1).

The search dialog list may provide the following information: Transcript excerpt at that time, Outline segment at that time, what time in the movie. A user may double click to get a selection to activate. Clicking cancel causes the dialog box to disappear. A status window is presented when preloading the transcript the first time. A 2-second pause may be provided between searches for very fast searches. Give a discrete error message if the search ‘fails’, e.g. no results.

Process Flow

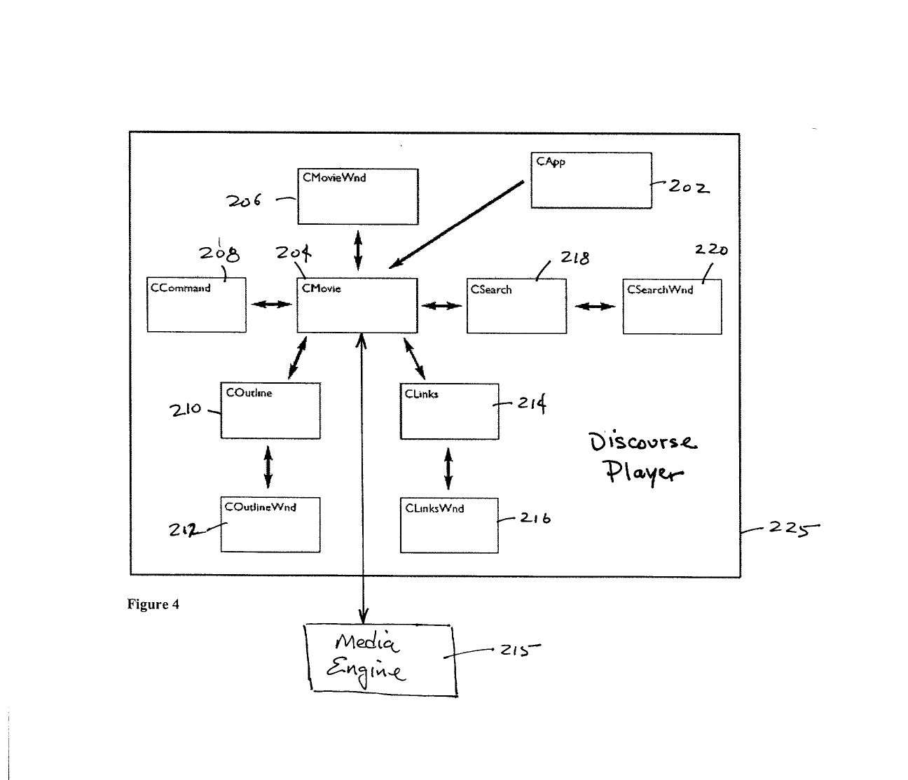

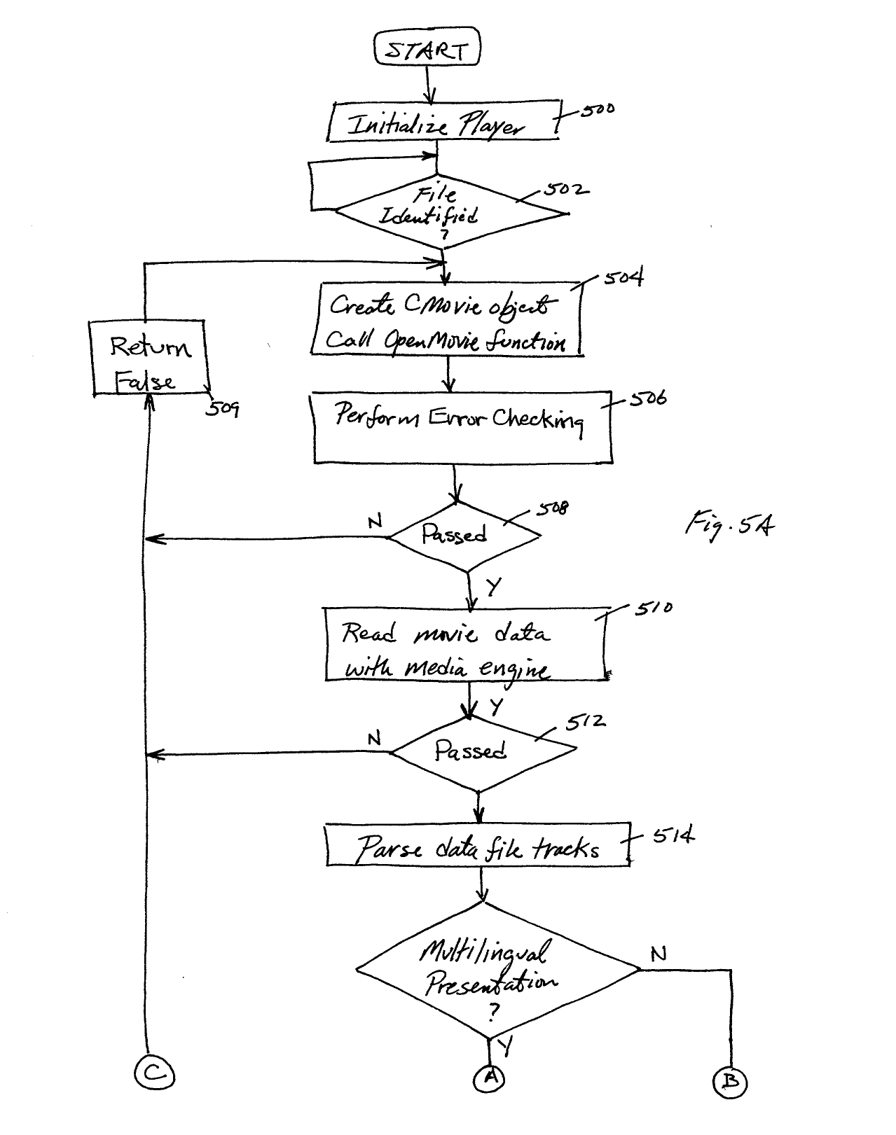

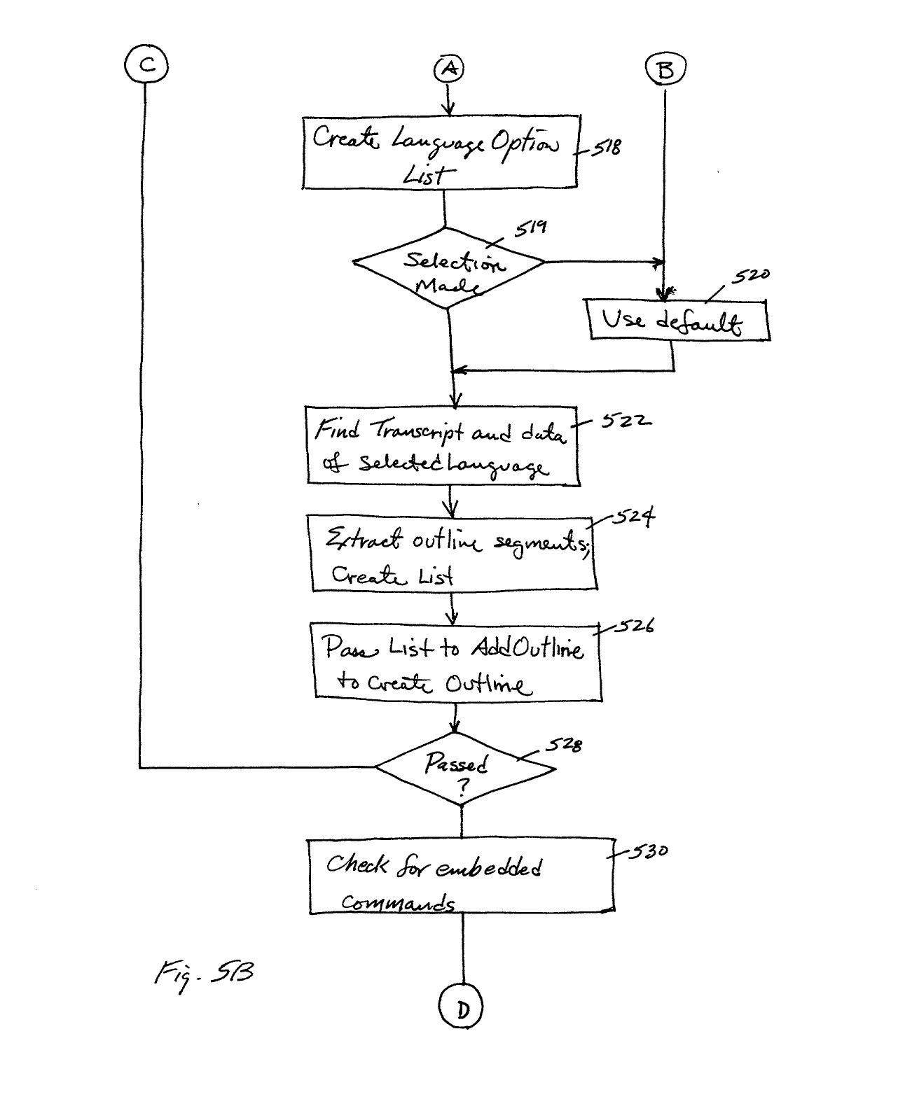

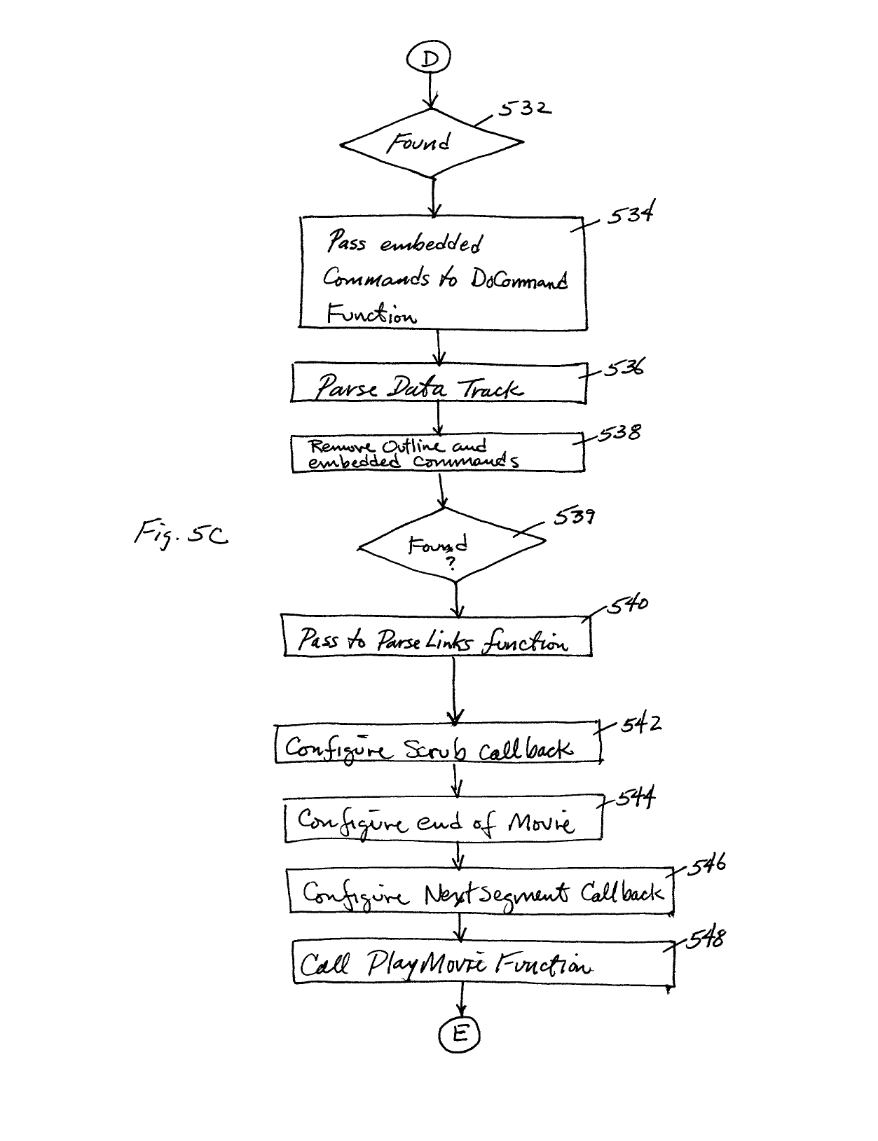

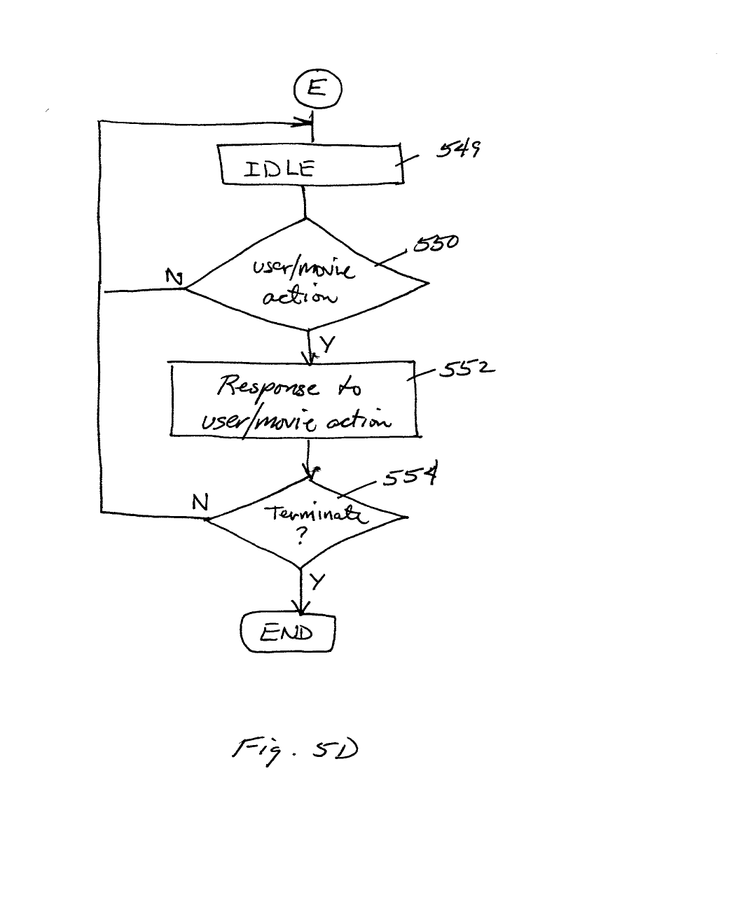

FIG. 4 is a conceptual diagram of the key objects utilized to implement the Discourse player 225 of the present invention and the possible control paths between the objects and media engine 215. The process initialization of the Discourse player 225 and playing a movie is illustrated by the flow chart of FIGS. 5A-D. To begin, the CApp object initializes the Discourse player 225 program, depending upon the operating system 250 being used, as illustrated by procedural step 500. If the CApp object is given a filename, for example through a drag and drop or command-line selection, as illustrated by decisional step 502, the CApp object creates the CMovie object 204, and calls the OpenMovie function of object 204 to start the process, as illustrated by procedural step 504. Next, the OpenMovie function performs some basic error checking to make sure that the movie passes some defined requirements, as illustrated by procedural step 506. In the illustrative embodiment, these requirements may be to ensure that the movie contains at least one video track, one audio track and two text tracks. If error checking fails, the OpenMovie function exits and returns FALSE value, as illustrated by decisional step 508. Otherwise, the movie is read through the Quicktime or other media engine 215, as illustrated by procedural step 510. If reading of the movie fails, the OpenMovie function exits and returns FALSE value, as illustrated by decisional step 512.

Otherwise, the OpenMovie function parses through the tracks, too see if the movie is a multilingual movie, as illustrated by procedural step 514 and decisional step 516. If the movie is multilingual, then a list of all available languages is created, and the user is prompted to select one of the languages, as illustrated by procedural step 518. If the movie is not multilingual, the base language of the movie is selected by default, as illustrated by procedural step 520.

Next, the OpenMovie function finds the transcript and data tracks of the selected language, as illustrated by procedural step 522. Thereafter, the OpenMovie function parses through the data track, extracts the outline segments, creates a list, as illustrated by procedural step 524. This list is passed to the OutlineObj::AddOutline function of the COutline object 210, as illustrated by procedural step 526. If the AddOutline function returns a false value, then the OpenMovie function exits and returns a False value, as illustrated by decisional step 528.

Otherwise, the OpenMovie function checks to see if there are any imbedded commands at the start of the movie, as illustrated by procedural step 530 and decisional step 532. If so, the embedded commands are individually passed to the CommandObj::DoCommand function of the CCommand object 208, as illustrated by procedural step 534. Next, the OpenMovie function extracts the data for the start of the movie from the data track, as illustrated by procedural step 536, and removes any outline and imbedded command portions, as illustrated by procedural step 538. These commands are then passed to the LinksObj::ParseLinks function of object 214, as illustrated by procedural step 540.

Next, the OpenMovie function configures the scrub-callback in the media engine 215 for the movie and directs it to the ScrubCallback function of the CMovie object 204 as illustrated by procedural step 542, in the event that the user selects noncontiguous portions of the movie. Similarly, the OpenMovie function configures the end-of-movie callback in the media engine 214 and directs it to the EndMovieCallback function of object 204, as illustrated by procedural step 544, to anticipate the movie end. Similarly, the OpenMovie function configures the next-segment callback in the media engine 215 and directs it to the NextSegmentCallback function of object 204, as illustrated by procedural step 546, to anticipate when the next outline segment is reached. Thereafter, the OpenMovie function calls the PlayMovie function of the OpenMovie object 204, as illustrated by procedural step 548.

Once the movie is loaded, the Discourse player 225 sits idle in a message-loop waiting for some sort of input, as illustrated by procedural step 549. Input could be both user actions or movie actions. A movie action is defined as an automatic action that takes place without user input. Once an action occurs, as illustrated by decisional step 550. Discourse player 225 takes appropriate action and then and waits again, as illustrated by procedural steps 549 and 552. The state changes and their respective responses within player 225 are implemented in a multi-threaded state machine implementation.

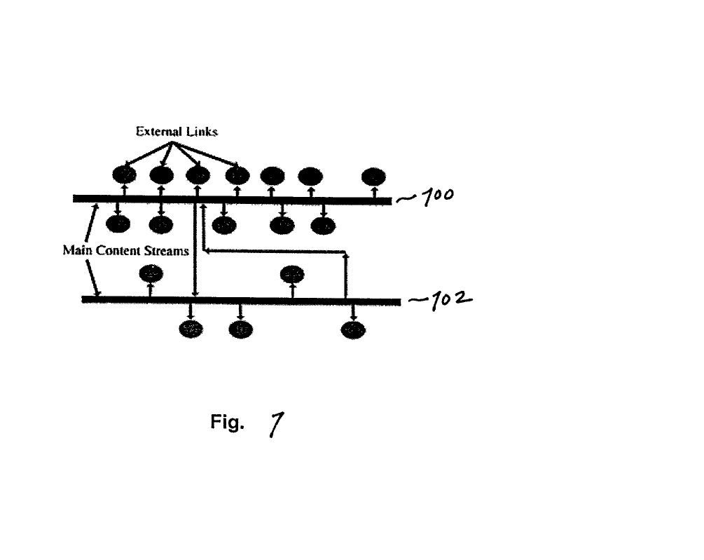

FIG. 7 illustrates conceptually the presentation flow of a multimedia presentation using the Discourse system 200 of the present invention. As opposed to the convoluted path in which pages relate to one another as illustrated in FIG. 1, the presentation flow of the Discourse system 200 includes multiple main content streams from which links to other streams or external data may be made directly. As illustrated, two main content streams 700 and 702 provide the presentation content. Links to other segments within each stream are possible utilizing the user interface presented by the Discourse player 225 as described herein. In addition, utilizing the linking data from the data track links to data sources, external to Discourse system 200, may be established during the presentation. In the illustrative embodiment, such external links will pause the presentation temporarily and return the viewer to the presentation when the external link is terminated.

User Interface

The Discourse player 225 and user interface 230 presents several windows to the user. Each of these windows can be hidden or displayed, enabled or disabled, and moved around the screen at the discretion of either the user or the presentation creator. FIG. 6 illustrates the various windows of a user interface 230 presented by Discourse system 200. Specifically, user interface 230 comprises a main window 232, an outline window 238, a relevant links window 234, and a notes window (not shown).

Main window 232 contains the Discourse presentation itself. Video and slides are displayed in window 232. The transcript of the presentation is displayed in window 232 as well. The size of window 232 is completely variable, from postage stamp internet video to full-screen files, depending on the needs and settings contained within a Discourse file 205 and the capabilities of the playback hardware.

At the bottom of window 232 is a toolbar 240 that contains buttons to control playback of the presentation. The toolbar 240 contains standard VCR-like controls over playback (play, pause, fast-forward, rewind) as well as Discourse-specific controls like Next and Previous Topic, Search, and controls to show and hide the transcripts and other windows.

Users can also select ‘hotspots’ within the video area of Window itself. These hotspots can be linked to any Discourse feature, including navigating through the material, controlling visibility of windows, or launching external resources.

Main window 232 also provides progress information to the user through the control bar 237 immediately under the video, a moving marker in bar 237 shows how far a user has progressed within a given Discourse file 205.

Outline Window 238 is a palette-style window that displays the current Discourse file's index in outline form. Users can collapse and expand the outline to see more or less detail. Selecting any given outline entry will immediately take the user to that point in the presentation. This feature can be disabled at the creator's discretion. The Outline Window 238 also provides progress feedback and context information to the user by highlighting the current outline segment and may be visible by default. Alternatively, a visual icon 239 may be utilized to indicate the current segment.

Links window 234 is a palette-style window that contains a list of links relevant to the material being presented in main window 232 and may be visible by default. These links are time-relevant, meaning that they change as the user progresses through the material. Only links that are relevant to the current material are shown. Selecting one of these links will pause the current presentation and open the link. Media types supported by links may include local or remote World Wide Web pages, video, audio, animations, other Discourse files, and even executable applications.

The Notes Window, not shown, provides a convenient place for users to enter notes from the keyboard as a Discourse file plays. These notes can be saved and printed.

The user interface of the Discourse player may be designed to obey the standard user interface guidelines of the native operating systems 250. Unlike other multimedia player environments which take over the entire screen, blocking out other applications, a Discourse presentation uses standard windowing routines that co-exist with other applications. The user interface of the illustrative embodiment of Discourse player 200 is described in greater detail below.

Main Movie Window

The main movie window 232 holds the presentation movie itself. Below the movie region is a standard movie controller bar 237, with volume control (if relevant), play/pause control, the scrub (progress) bar, and frame forward & backward controls.

Below the movie controller bar 237 may be buttons relating directly to the overall movie, including Next Segment, Previous Segment, Search, Bibliography, Credits, Show/Hide Links, Show/Hide outline, and Go Back. These buttons may be the same height as the controller, and match the general appearance of the controller.

Main movie window 232 may be resizable by the user with the normal resizing controls. However, since QuickTime is more efficient with certain sizes and proportions. In the illustrative embodiment, this window may be automatically set or “snap” to the closest of these efficient sizes. For example, if a user wants to resize a 600×240 movie to horizontally fill a 1024×768 display, the user drags the sizing control to the corner right edge of the screen. Without the snap this would result in a movie with dimensions of 930×371. With the snap this movie is scaled to 928×360. These dimensions use a vertical scale factor of 1.5, which is an efficient number, and a horizontal scale factor of 1.56, which while not particularly efficient in terms of transformation, is divisible by 16 which usually results in increased performance of most graphics cards. If the user had dragged the window to 900×350 the snap would have brought it to 896×360. If the user dragged it to 890×300, the snap would have brought it to 896×300. If possible, the bounding box displayed while resizing may reflect to where the window will snap. Holding down the shift key while resizing may retain the movie's original aspect ratio. Performance issues may override this aspect ratio up to 5% of the size. Holding down the control key while resizing may inhibit the snap altogether.

When moving the window, the code may make sure that the origin point is at an efficient pixel. Some displays exhibit improved performance when regions begin on certain pixel values, usually divisible by 4. All parts of the window may be displayed on one monitor with no parts extending past the edges unless it is clear, e.g. >10% of pixels, that the user so desires.

Color

Color may be used in the overall interface. The standards for the Macintosh and Windows operating system gray three dimensional appearance may suffice. When color is used, it may follow these guidelines:

Green—for navigation, going somewhere

Blue—for help, intelligent assistance

Red—something destructive, quitting for example

Yellow—semi-destructive actions, going back to a previous presentation, initiating a long search, etc.

These colors may be used together, for example, a link button that is half green and half yellow.

Icons for other programs or presentations may retain their original colors, but effort may be made to integrate these icons with the standard color-scheme. For example, a link to go to MS Word would contain the program's icon with its normal colors on a small field with the bottom half green and the top half yellow because it will result in the user leaving the player and going to MicroSoft Word—the green gets the higher influence position because the act is primarily one of navigation.

Outline Window

The Outline window 238 is a palette-type window that holds the outline of a presentation in a collapsible and expandable hierarchical list. Selecting on any line of this list will cause the movie window to go to the time in the presentation corresponding to the segment identified by the selected outline entry.

The outline may appear in the standard indented format, with icons displayed in front of each new outline entry which indicate whether it is a collapsed or expanded hierarch or a content-containing detail. As the presentation plays the corresponding outline item may be highlighted. If the corresponding outline item is collapsed, its nearest visible hierarch may be highlighted.

The duration, in minutes and seconds, of the segment may be displayed next to each entry. If the entry is a hierarch then the sum of the times of it children may be displayed in italic. These durations may reside in a resizable column on the right side of the window. The range of sizes for this column may be between the size of the maximum duration entry, plus some aesthetically pleasing amount of space, and two, which allows for a thin white line between the border of the column and the border of the window. When resized, this column may crop from the right to the left, so that the seconds are the first things to disappear when scaled below normal size.

Window 238 is used for all documents (presentations) opened by the player and contains the outline to whichever document has user-focus. If the document with user-focus has no outline, this window may display, centered on all axes, a “No Outline Present” message.

When not using the Windows MDI Parent/Child window model, this window may disappear whenever the player does not have user-focus. When using the MDI Parent/Child interface it may remain visible.

Selecting an outline entry seeks the movie/presentation to the point referenced by the outline. The presentation will begin playing as soon as the seek is completed, as long as the user hasn't clicked anywhere else in the meantime.

Selecting the twiddles in front of outline hierarchs will collapse or expand them. The state of the icon may reflect their collapsed or expanded state. Collapsing and expanding may be accompanied by the twiddle animating to it's new to avoid visual confusion.

Relevant Links Window

The Relevant Links window 234 is a palette-type window that contains the list of links in the current section of the presentation. Each link can be selected to hyperlink to the document to which it points. Links may be displayed flush left in the window. Links may have an icon to the left, representing the kind of data to which it points. For example, a pointer to a web page may contain a small icon of the networked world; a pointer to another Discourse presentation may contain the Discourse presentation data icon; a pointer to a still graphic may use the PICT icon, etc.

Window 238 is used for all documents (presentations, etc) opened by the player, it contains the links for whichever document has user-focus. If the document with user-focus has no annotation track, this window may display, centered, a “No Links Present” message. If the document with user-focus has an annotation track, but no links, this window may remain blank.

When not using the Windows MDI Parent/Child window model, this window may disappear whenever the player does not have user-focus. When using the MDI Parent/Child interface it may remain visible.

Selecting any entry in the window 234 activates that link. The player 225 will activate the program necessary for that type of link and pass it the URL of the link in the format that the program needs. If the Discourse player 225 itself is capable of opening the file, it will open the file and give that new file user-focus. If the file is playable it will be played automatically. Whenever a link is activated the current presentation will pause.

If the file is a Discourse presentation it will be stopped after the referenced outline segment is completed and the user will be given a dialog box saying “The outline segment referenced by your link has finished. You may return to your original presentation by clicking Go Back, or you may continue using this presentation by clicking Continue. If you choose to continue you can return to your original presentation at any time by clicking the Go back button in the movie window.” Or similar message. Choices in the dialog may be “Go back”, “Continue”, and “Continue & Don't Show This Dialog Again”. Selecting “Go back” may return the user to the referencing presentation and close the current movie. Selecting “Continue” may return the user to the current presentation and play the current presentation automatically. Selecting “Continue and Don't Show This Dialog Again” may return the user to the current presentation, play the current presentation automatically, and mark a flag that will suppress the stopping and asking how to continue behavior entirely. Any presentation referenced later is this session may play as if it were opened normally.

If window 234 contains an Email to Instructor button, selecting that link opens up the user's email program and creates a new message window, passing it the email address of the instructor or contact (from the annotation track), name of the Presentation, the outline segment reference, the user's history (how long they've spent on segments, what links they've accessed, and other stuff TBD), and their reference code. The user then types their question and sends it to the instructor.

Control Panel

Control Panel window 240 is a small palette-type window that contains larger, more obvious controls for movie window 232, including Play/Pause, Fast Forward, Rewind, Next Segment, Previous Segment, Search, Show/Hide Links, Show/Hide outline, and Go Back. These controls are outlined in greater detail below.

Selecting the Next Segment button seeks the movie to the beginning of the next outline item. Play status is not effected by selection of this control. If the movie is paused when selected, the movie stays paused, if playing the movie continues playing.

Selecting the Previous Segment button seeks the movie to the beginning of the current outline item. If the movie is already on the first frame of the current outline item, it will seek the movie to the beginning of the previous outline item. If the button has already been selected within two seconds of the completion of the last seek, it automatically goes to the beginning of the previous outline item. Play status is not effected by selection of this control. If the movie is paused when selected, the movie stays paused, if playing the movie continues playing.

Selecting the Previous Search button causes a standard search dialog will appear. The dialog will default to search the transcript and outline tracks of the current presentation by keyword.

Selecting the Bibliography button calls to another application (the system's default word processor preferably) with the RTF file contained in the Bibliography Atom of the presentation file. If the current movie has no Bibliography Atom, this button may be inactive.

Selecting the Credits button shows a model (titleless, non-resizable, always in front) window that scrolls the contents of the Credits Field of the About Box Atom of the presentation file.

Selecting the Show/Hide Links button will hide the Links window if it is visible, and show the Links window if it is invisible. The state of the button may reflect the state of the window 234. If window 234 is visible the button may show the Hide graphic, if window 238 is invisible it may show the show graphic.

Selecting the Show/Hide Outline button will hide the Outline window if it is visible, and show the Outline window if it is invisible. The state of the button may reflect the state of the window 238. If window 238 is visible the button may show the Hide graphic, if window 238 is invisible it may show the Show graphic.

Selecting the Go Back button will cause a return to the presentation that referenced the current presentation, if relevant, and close the current presentation. Holding down the control while clicking will return the user to referencing movie without closing the current movie. Clicking and holding down may return a pop-up menu containing a list of all the calling presentations. selecting one of the presentations from the list will return cause a return to that selection. Returns are not added to the return list of the destination movie.

The following menu options may be provided in window 242 in the hierarchy lists below:

Menus

File

Open

Close

?Save

?Save as

Print

Slide

All Slides

Movie Frame

Full Outline

Outline as Displayed

Links

Check for EMail

Edit

Cut

Copy

Slide

Movie Frame

Movie Selection

Outline

Outline Selection

Links

Link Selection

Paste

Preferences

The following open windows may be further provided:

Help/Info

Search Lecture

Search All Available Lectures

About Current Lecture

Send email to instructor

Topics

Search Dialog

Player language Selection

Determine local language Region

Deactivate all that are not in that region or US

Player Search Path

Hard Location From Link

Local DisCourse Prefs

Annotation track

Current Directory

DisCourse Software Directory

Directory of CD-ROM Drive

Prompt User

Search Local HD

Search Network HDs

Discourse File Format

All tracks may have their language specified in the track media atom header. All tracks may have user data atoms containing the numeric codes of all the languages they are to be shown with.

A video track may be any fixed position track that contains data with a constant or near constant frame rate above 2 Hz. Valid Discourse presentations may contain an arbitrary number of video tracks at any compatible location, with any compatible transformations, but are not required to have any video tracks at all. Video tracks may be compressed using CinePak, Indeo, MPEG, (M)JPEG, or Apple Video codecs, which are optimized for compressing slightly noisy, medium to high-framerate, high-color source streams.

A slide track may be any fixed position track that contains data with a variable framerate, typically below 2 Hz. Valid DisCourse presentations may contain an arbitrary number of slide tracks at any compatible location, with any compatible transformations, but are not required to have any slide tracks at all. Slide tracks may be compressed using Animation, Graphic, or JPEG codecs, which are optimized to produce high-quality still images at several bit-depths.

The Audio Track contains a stereo or mono stream of audio information. Discourse presentations are strongly discouraged from using muxed data (like muxed MPEG a/v files and some Indeo 4 files). Separate audio and video streams facilitate localization and technology-based updates. Discourse presentations are not required to have an audio track.

Transcript tracks are time-synchronized text tracks that may contain the full-text transcript of a presentation. Resolution of individual samples may be at the sentence or bi-sentence level.

The option Hit Track is a graphic track that contains the regions for selectable areas within a movie's boundaries. The frame rate may be variable and typically very low. New samples need to inserted whenever the selectable regions change. The number of times selectable regions change may be minimized. The color of a pixel in the hit track may determine what link gets activated by a selection.

The Annotation Track may includes the following:

Annotation Tracks

outline data

link data

Links Window entries

Hit Track entries

email data

extra fields for future versions

Bibliography Atom

Contains an RTF file that is the bibliography of the lecture

About Box Atom

Title

Description

Objective

Copyright Date

Copyright Holder

Creation Date

Last Modification

Contact Information

Name

Department

Address

Phone Number

Fax number

Email address

Graphic Yummie

Credits

Big rich text field, should be unlimited in size.

Version History Atom

{list of last 40 changes}

Date

Who changed it

What was changed

Why it was changed

Who requested the change

Printable Outline Atom

Contains an .RTF file of the outline with any notes, elaborations, etc. the instructor wishes to be in a printed version.

Discourse Data File

The Discourse system 200 uses a single data file 205 to hold all the media for the main linear content stream of the Discourse data file. This single data file contains the sound, video, still graphics, transcript, annotations, and other media types that can be included in a Discourse presentation. Data in a Discourse file is interleaved in a way that facilitates later modification and editing without the need to reference original source media. This means that an on-site administrator can copy and paste content between different Discourse files to add or remove portions, or construct a customized lesson from smaller pieces.

The Discourse data file format supports all standard data types: video, sound, still graphics, text, animations, sprites, and even 3D models. Discourse further includes annotation of media with outline entries, transcripts, hyperlinks, and even selectable areas and command scripts. These different media types can be mixed and matched with each other in a Discourse data file 205 in any proportion. This includes side-by-side display, overlays, and interaction between layers through techniques like real-time chroma-keying. Additionally these media data types can be stored and played back at a wide variety of sizes and data rates. The Discourse format does not force creators into any fixed screen resolutions, video sizes, compression schemes, on-screen layouts, or enforce any maximum or minimum data rates.

Because the Discourse system 200 uses the player and data content delivery model and uses only one file 205 to store the data for an entire presentation, delivery, deployment and administration are far easier to manage and much less prone to technical difficulties than other multimedia options. Additionally Discourse content is not tied to any particular delivery medium. Discourse files will run equally well from a CD-ROM, DVD, hard disk, optical drive, or network server. Discourse content can be delivered through a wide variety of digital mechanisms, including DVD, CD-ROM, intranets, the Internet, magneto-optical disks, even Jaz and ZIP disks.

Raw video, as on a videotape, could consume up to 27 Megabytes per second of disk space, so compression of the data in any digital video file is essential for efficient distribution. Discourse hooks into the standard codecs (compressor/decompressor) included with QuickTime 3.0 and subsequent revisions to assure compatibility with the widest variety of computer hardware. The Discourse system 200 also supports a variety of pre- and post-processing techniques to further reduce the size of a final file, allowing more content to be placed on a given medium (whether that's CD-ROM, DVD, or on a network server volume).

Authoring Tools

The authoring tools provided with the Discourse system 200 can integrate nearly any kind of data media (analog or digital) into a Discourse file. The Discourse authoring tools also support integration of chroma-key or blue-screen video to achieve extremely high video compression ratios as well as superior integration of presenters and their A/V materials.

Administrative tools currently under development include on-site editing tools, server-based tracking and management software, network content servers, as well as an advanced server-based content customization tool. On-site editing tools allow local administrators to modify existing Discourse content files without the need to go back to the service provider. Content can be copied from one Discourse file and pasted into another or obsolete material can be easily cut from existing presentations for unprecedented ease of customization. Discourse materials can be made from multiple different content types. Typical media types include videotape, PowerPoint presentations, web pages, and 35 mm slides.

The reader will appreciate that the inventive Discourse system represents a new way of looking at the problem of interactive training. Rather than spending large amounts of time and money planning an elaborate page based training product, Discourse's just-in-time approach facilitates rapid reuse and migration of existing content without sacrificing effectiveness or persuasiveness of multimedia. Discourse's player and data approach and use of standard interface elements reduce startup and support costs while Discourse's flexibility allows content to be optimized for and deployed on a variety of media including CD-ROM, DVD, and network servers.

A software implementation of the above described embodiment(s) may comprise a series of computer instructions either fixed on a tangible medium, such as a computer readable media, e.g. diskette 142, CD-ROM 147, ROM 115, or fixed disk 152 of FIG. 1, or transmittable to a computer system, via a modem or other interface device, such as communications adapter 190 connected to the network 195 over a medium 191. Medium 191 can be either a tangible medium, including but not limited to optical or analog communications lines, or may be implemented with wireless techniques, including but not limited to microwave, infrared or other transmission techniques. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, e.g., shrink wrapped software, preloaded with a computer system, e.g., on system ROM or fixed disk, or distributed from a server or electronic bulletin board over a network, e.g., the Internet or World Wide Web.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. Further, the methods of the invention may be achieved in either all software implementations, using the appropriate processor instructions, or in hybrid implementations which utilize a combination of hardware logic and software logic to achieve the same results. Further, aspects such as the size of memory, number of bits utilized to represent datum or a signal, data word size, the number of clock cycles necessary to execute an instruction, and the specific configuration of logic and/or instructions utilized to achieve a particular function, as well as other modifications to the inventive concept are intended to be covered by the appended claims.

What is claimed is:

1. Apparatus for displaying content from a data file comprising:
a media engine for presenting content data from the data file;
program logic for streaming content data from the data file and for coordinating a presentation of the content data by the media engine, the presentation having a plurality of data segments;
program logic for displaying an outline of the presentation during display of the presentation; and
program logic for accessing one of the plurality of data segments within the presentation upon selection of a corresponding portion of the outline of the presentation.

2. In a computer system having a display and capable of generating a presentation from a stream of data, a method comprising:
(a) accessing the stream of data;
(b) extracting content data from the stream of data;
(c) presenting the content data on the display;
(d) extracting outline data representing a plurality of data segments within the presentation, the data segments linked to respective segments of the presentation; and
(e) presenting the outline data on the display simultaneously with the presentation of the content data.

3. The method of claim 2 wherein the plurality of segments within the presentation are arranged in a hierarchical relation and wherein (f) comprises:
(f.1) presenting the outline data in a hierarchical arrangement, portions thereof which are user selectable.

4. The method of claim 3 further comprising:
(g) generating a position icon and traversing the hierarchical arrangement of outline data in correspondence with presentation of the content data.

5. The method of claim 3 further comprising:
(g) upon selection of a portion of the outline data, resolving the link to the associated data segment within the presentation; and
(h) presenting the content data from the data stream associated with the selected segment.

6. A computer program product for use with a computer system having a display and capable of generating a presentation from a stream of data, the computer program product comprising a computer useable medium having program code embodied therein comprising:
(a) program code for accessing the stream of data;
(b) program code for extracting content data from the stream of data;
(c) program code for presenting the content data on the display;
(d) program code for extracting outline data representing a plurality of data segments within the presentation, the data segments linked to respective segments of the presentation; and
(e) program code for presenting the outline data on the display simultaneously with the presentation of the content data.

7. The computer program product of claim 6 wherein the plurality of segments within the presentation are arranged in a hierarchical relation and wherein (f) comprises:
(f.1) program code for presenting the outline data in a hierarchical arrangement, portions thereof which are user selectable.

8. The computer program product of claim 7 further comprising:
(g) program code for generating a position icon and traversing the hierarchical arrangement of outline data in correspondence with presentation of the content data.

9. The computer program product of claim 6 further comprising:
(g) program code for upon selection of a portion of the outline data, resolving the link to the associated data segment within the presentation; and
(h) program code for presenting the content data from the data stream associated with the selected segment.

10. In a computer system having a display and capable of generating a presentation from a stream of data, a method comprising:
(a) accessing the stream of data;
(b) extracting content data from the stream of data;
(c) presenting the content data on the display;
(d) extracting linking data representing at least one link to data other than the presentation data associated therewith, the linking data linked to other data sources; and
(e) presenting the linking data on the display simultaneously with the presentation of the content data.

11. The method of claim 10 further comprising:
(f) pausing the display of the content data and establishing a link to the other data upon selection of the linking data by a user.

12. The method of claim 11 wherein the source of data is the stream of data.

13. The method of claim 11 wherein the source of data is external to the stream of data.

14. A computer program product for use with a computer system having a display and capable of generating a presentation from a stream of data, the computer program product comprising a computer useable medium having program code embodied therein comprising:
(a) program code for accessing the stream of data;
(b) program code for extracting content data from the stream of data;
(c) program code for presenting the content data on the display;
(d) program code for extracting linking data representing at least one link to data other than the presentation data associated therewith, the linking data linked to other data sources; and
(e) program code for presenting the linking data on the display simultaneously with the presentation of the content data.

15. Apparatus for displaying content from a data file comprising:
a media engine for presenting different media types from the data file;
program logic for streaming data from the data file and for coordinating presentation of the data by the media engine;
program logic for displaying relevant links from the data stream to other data; and
program logic for resolving relevant links to the other data.

16. In a computer system having a display and capable of generating a presentation from a stream of data, a method comprising:
(a) accessing the stream of data;
(b) extracting content data from the stream of data;
(c) presenting the content data on the display;
(d) extracting selection data representing at least one user-selectable region within the presentation of the content data, the user-selectable region associated with a command; and
(e) modifying the presentation of the content data upon selection of the user-selectable region associated with a selectable command.

17. The method of claim 16 wherein (d) further comprises:
(d.1) extracting data representing a plurality of user-selectable regions within the presentation of the content data, each user-selectable regions associated with a command.

18. The method of claim 16 wherein (e) comprises:
(e.1) navigating through the presentation of the content data.

19. The method of claim 16 wherein (e) comprises:
(e.1) pausing the presentation of the content data and establishing a link to the other data.

20. In a computer system having a display and capable of generating a presentation from a stream of data, a method comprising:
(a) providing a data file containing a stream of data having internal commands and user selectable options interleaved in the stream with presentation data;
(b) extracting the presentation data from the data file and generating a presentation thereof;
(c) extracting the internal commands from the data stream and interpreting the internal commands;
(d) extracting the user selectable options from the data stream and presenting the user selectable options superimposed over the presentation; and
(e) manipulating the presentation in response to selection of one of the user selectable options.

21. Apparatus for displaying content from a data file comprising:
a media engine for presenting content data from the data file;
program logic for streaming content data from the data file and for coordinating a presentation of the content data by the media engine, the presentation having a plurality of data segments and relevant links from the data stream to other data; and
program logic for displaying an outline of the presentation and relevant links from the data stream to other data during display of the presentation.
